(19) United States
(12) Patent Application Publication
(10) Pub. No.: US 2016/0084184 A1
(43) Pub. Date: Mar. 24, 2016

(54) EXHAUST SYSTEM HAVING AFTERTREATMENT REGENERATION CYCLE CONTROL

(71) Applicant: Progress Rail Services Corporation, Albertville, AL (US)

(72) Inventors: Douglas Michael Biagini, Washington, IL (US); Aaron Michael Harmon, Dunlap, IL (US)

(73) Assignee: PROGRESS RAIL SERVICES CORPORATION, Albertville, AL (US)

(21) Appl. No.: 14/491,028

(22) Filed: Sep. 19, 2014

(51) Int. Cl. F02D 41/14; F02D 41/00

(52) U.S. Cl. CPC F02D 41/1446; F02D 41/0007; F02D 41/1439

(57) ABSTRACT

An exhaust system for an engine is provided that may have an exhaust passage configured to direct exhaust from the engine to the atmosphere. The exhaust system may also have an aftertreatment component disposed within the exhaust passage, a throttle configured to generate a throttle position signal indicative of a throttle position of the engine, and a temperature sensor configured to generate a temperature signal indicative of the exhaust temperature. The exhaust system may also have a controller in communication with the engine, the throttle, the sensor, and the aftertreatment component, configured to monitor the temperature signal and track a total duration for which the temperature signal is less than a threshold temperature. The controller may also be configured to initiate a load increase on the engine to raise a temperature of exhaust exiting the engine when the total duration is greater than a threshold duration. The threshold temperature and the threshold duration vary during operation of the engine, and are determined by the controller based on one or more inputs including at least the throttle position.

### TECHNICAL FIELD

The present disclosure is directed to an exhaust system, more particularly, to an exhaust system having aftertreatment regeneration cycle control.

### BACKGROUND

Engines, including diesel engines, gasoline engines, gaseous fuel powered engines, and other engines known in the art exhaust a complex mixture of air pollutants. These air pollutants can include gaseous compounds, such as the oxides of nitrogen, hydrocarbons, and solid material known as particulate matter or soot. Due to increased attention on the environment, exhaust emission standards have become more stringent and the amount of gaseous compounds and solid material emitted from an engine is regulated depending on the type of engine, size of engine, and/or class of engine.

One method implemented by engine manufacturers to comply with the regulation of pollutants exhausted to the environment has been to reduce, convert, or otherwise remove the gaseous compounds, hydrocarbons, and particulate matter from the exhaust flow of an engine with aftertreatment devices such as catalysts and filters. These aftertreatment devices, however, may only function efficiently under particular operating conditions. For example, some catalysts only function efficiently when exposed to elevated temperatures. Thus, during low exhaust temperature operation, for example during extended periods of idling and/or low temperature operation, the catalyst will adsorb hydrocarbons because the light-off temperature curve does not have sufficient temperature to completely oxidize the hydrocarbons. In order to completely oxidize the hydrocarbons from the exhaust flow and those adsorbed into the catalyst, the exhaust temperature must be increased to a sufficient temperature. However, if loading of the engine system was to occur with an aftertreatment system that contained adsorbed hydrocarbons, the hydrocarbons could ignite causing an exothermic event that could potentially damage or destroy the catalyst. Additionally, if the adsorbed hydrocarbon did not ignite, the hydrocarbon would be released in the form of a white smoke plume which is undesirable. Accordingly, some engine exhaust systems are equipped with means for artificially raising a temperature of the exhaust passing through the catalysts and filters in order to oxidize the adsorbed hydrocarbons in a controlled manner.

An exemplary exhaust system configured for substance accumulation reduction is disclosed in U.S. Pat. No. 7,788,911 of Zhang et al. that published on Jan. 24, 2008 (“the '911 patent”). Specifically, the '911 patent discloses an engine and exhaust system that monitors the time when the exhaust temperature is below an absorption temperature and above an absorption temperature and if the accumulated time below the absorption temperature exceeds a maximum threshold, a control unit enters desorption or thermal management mode. The thermal management mode causes the control unit to direct the engine to produce exhaust gas at a higher temperature level thereby oxidizing the matter accumulated within the exhaust system.

Although the system of the '911 patent may adequately function to regenerate an oxidation catalytic, it may still be less than optimal. Specifically, the system may not consider important inputs when determining the threshold for initiating regeneration and may not consider operating conditions of the engine during regeneration that could improve an efficiency of the regeneration process.

The disclosed system and method address one or more of the problems discussed above and/or other problems of the prior art.

### SUMMARY

One aspect of the present disclosure is directed to an exhaust system. The exhaust system may include an exhaust passage configured to direct exhaust from the engine to the atmosphere. The exhaust system may also include an aftertreatment component disposed within the exhaust passage. The exhaust system may further include a throttle configured to generate a throttle position signal indicative of a throttle position of the engine, and a temperature sensor configured to generate a temperature signal indicative of the exhaust temperature. The exhaust system may also include a controller in communication with the engine, the throttle, the sensor, and the aftertreatment component. The controller may be configured to monitor the temperature signal and track a total duration for which the temperature signal is less than a threshold temperature. The controller may also be configured to initiate a load increase on the engine to raise a temperature of exhaust exiting the engine when the total duration is greater than a threshold duration. The threshold temperature and the threshold duration vary during operation of the engine, and are determined by the controller based on one or more inputs including at least the throttle position.

Another aspect of the present disclosure is directed to a method of controlling an exhaust system for an engine. The method may include receiving a temperature signal indicative of an exhaust temperature and receiving a throttle position signal indicative of a throttle position of the engine. The method may also include monitoring the temperature signal and tracking a total duration for which the temperature signal is less than a threshold temperature. The method may further include initiating a load increase on the engine to raise a temperature of exhaust exiting the engine when the total duration is greater than a threshold duration. The threshold temperature and the threshold duration vary during operation of the engine, and are determined based on one or more inputs including at least the throttle position.

Another aspect of the present disclosure is directed to an engine system. The engine system may include an engine, an exhaust manifold extending from the engine, and a turbocharger connected to the exhaust manifold. The engine system may also include at least one exhaust passage connected to an outlet of the turbocharger configured to direct exhaust to the atmosphere and an aftertreatment component disposed within the exhaust passage. The engine system may further include a throttle configured to generate a throttle position signal indicative of a throttle position of the engine and a temperature sensor configured to generate a temperature signal indicative of the exhaust temperature. The engine system may also include a controller in communication with the engine, the throttle, the sensor, and the aftertreatment component. The controller may be configured to monitor the temperature signal and track a total duration for which the temperature signal is less than a threshold temperature. The controller may also be configured to initiate a load increase on the engine to raise a temperature of exhaust exiting the engine when the total duration is greater than a threshold duration. The threshold temperature and the threshold duration vary during operation of the engine, and are determined based on one or more variables including at least the throttle position.

### BRIEF DESCRIPTION OF THE DRAWINGS

FIG. 1 is a schematic and diagrammatic illustration of an exemplary disclosed engine system.

FIG. 2 is a flow chart illustrating an exemplary disclosed method of operating the engine system of FIG. 1.

FIG. 3 is a flow chart illustrating an exemplary disclosed method of operating the engine system of FIG. 1 during a regeneration cycle.

### DETAILED DESCRIPTION

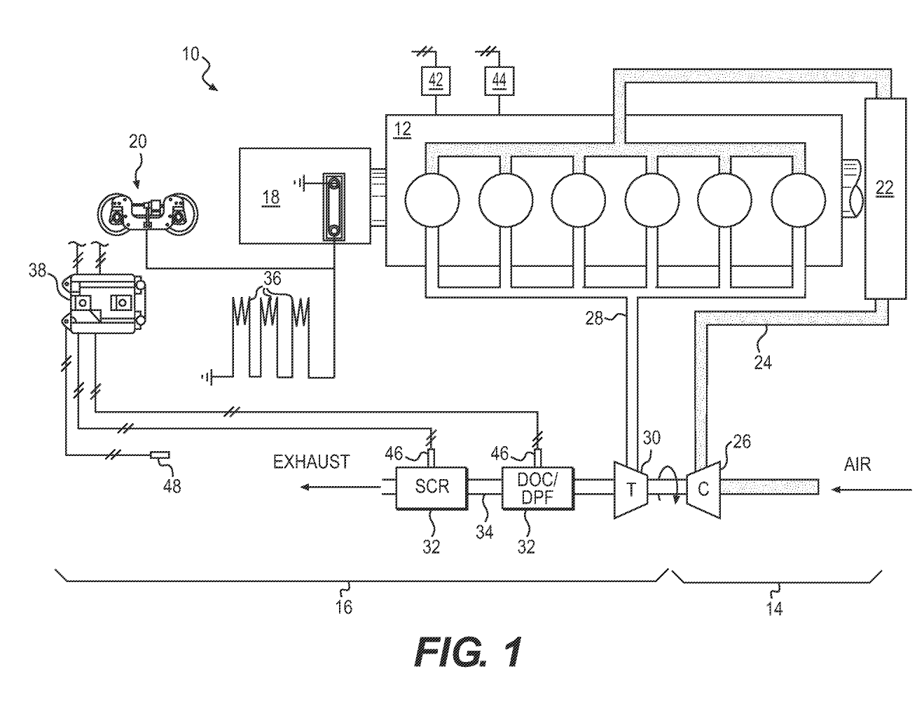

FIG. 1 illustrates an exemplary engine system 10 that may be used in a mobile application (e.g., the prime mover of a locomotive) or a stationary application (e.g., as the power source of a utility station). For the purposes of this disclosure, engine system 10 is depicted and described as including an internal combustion engine 12, an air induction system 14, and an exhaust system 16. Air induction system 14 may be configured to direct compressed air or a mixture of air and fuel into engine 12. Engine 12 may combust the air and fuel to generate a mechanical output and a flow of exhaust gases. Exhaust system 16 may be configured to direct the flow of exhaust gases from engine 12 to the atmosphere. One skilled in the art will recognize that engine system 10 may include any type of internal combustion engine, such as a two- or four-stroke diesel fueled, gasoline fueled, gaseous fueled, or blended fueled engine.

Engine 12 may be connected to a mechanical load that is configured to convert a rotational output from engine 12 to useful power. In the disclosed embodiment, engine 12 is connected to a primary generator 18 that converts the rotational output to electrical power, which can then be directed to an electrical component corresponding with the particular application of engine system 10. In one exemplary application, the electrical power can be directed to one or more traction motors 20 that propel a locomotive. In one exemplary stationary application, the electrical power can be directed to end consumers (e.g., via a utility grid) or used on site for other purposes (e.g., for pumping and/or drilling purposes). It is contemplated that the mechanical load that receives the rotational output from engine 12 could embody a device other than a primary generator, if desired.

Air induction system 14 may include multiple components that cooperate to condition and introduce compressed air or a mixture of compressed air and fuel into engine 12. For example, air induction system 14 may include an air cooler 22 located within an inlet duct 24 downstream of one or more compressors 26. Compressor(s) 26 may be configured to draw in air, pressurize the air, and direct the air through cooler 22 into engine 12 via inlet duct 24. As the air passes through cooler 22, cooler 22 may dissipate heat from the air to the atmosphere, thereby reducing a temperature and increasing a density of the air.

Exhaust system 16 may include multiple components that condition and direct exhaust from engine 12 to the atmosphere. For example, exhaust system 16 may include an exhaust duct 28, one or more turbines 30 driven by exhaust flowing through duct 28, and one or more aftertreatment components 32 fluidly connected downstream of turbine(s) 30. Exhaust from engine 12 may be directed to pass through turbine(s) 30 and thereby drive turbine(s) 30 to rotate compressor(s) 26 and compress inlet air. After exiting turbine(s) 30, the flow of exhaust may pass through aftertreatment component(s) 32 via exhaust passage 34 and be conditioned prior to discharge to the atmosphere.

Aftertreatment component(s) 32 may include any one or more of an oxidation catalyst (e.g., a diesel oxidation catalyst—DOC), a particulate filter (e.g., a diesel particulate filter—DPF), a reduction catalyst (e.g., a selective catalytic reduction device—SCR device), a cleanup catalyst (e.g., an ammonia adsorbing catalyst—AMOx catalyst), or another type of component known in the art that is used to convert, reduce, trap, remove, or otherwise condition constituents of the exhaust produced by engine 12. For exemplary purposes only, exhaust system 16 is shown in FIG. 1 as having a DPF that is configured to remove particulates (e.g., soot and unburned hydrocarbons) from the exhaust passing through duct 28, a DOC that is configured to oxidize hydrocarbons and carbon monoxide into carbon dioxide and water, and a SCR having a catalyst configured to convert nitrogen oxides (NO_{X}) with the aid of a catalyst into diatomic Nitrogen (N₂) and water. Although not shown, exhaust system 16 may further include injectors configured to dose a gaseous reductant, for example ammonia or urea, into the flow of exhaust upstream of the SCR, which is adsorbed onto the catalyst of the SCR.

After treatment component(s) 32 may be configured to operate optimally when exposed (at least periodically) to exhaust temperatures at or above a threshold value. For example, a particular catalyst may only convert or reduce constituents at a desired rate when the exhaust temperature is sufficiently elevated. In another example, the DPF may become saturated with soot over a period of time and require periodic exposure to higher exhaust temperatures for regeneration purposes. That is, the soot collected with the DPF may only be removed through oxidation, which occurs at temperatures elevated above a light-off temperature of the soot. In yet another example, the DOC may become saturated with hydrocarbons over a period of time if the exhaust temperature is below the threshold value and the oxidation or conversion rate is therefore below a desired rate. Hydrocarbons may also be adsorbed and build up within the SCR or other piping and components of exhaust system 16 when the exhaust temperature is below the threshold value.

The temperature of exhaust passing through aftertreatment component(s) 32 may be elevated by selectively increasing the mechanical load on engine 12, thereby causing engine 12 to combust a greater amount of fuel and increasing a resulting temperature of the exhaust passing through duct 28. The mechanical load on engine 12 can be increased by adjusting the operation of primary generator 18, such that primary generator 18 converts a greater amount of the mechanical rotation of engine 12 to electrical power. In other embodiments, a heater (not shown) may be used to directly heat the exhaust at a location upstream of aftertreatment component(s) 32 and downstream of turbine(s) 30. In yet another embodiment, an inlet valve (not shown) positioned in air induction system 14 can be throttled to adjust air inflow to engine 12. By throttling air inflow to engine 12, the air to fuel mixture ratio can be adjusted affecting the combustion of engine 12 and thereby the temperature of the exhaust passing through duct 28. In yet another embodiment, an outlet valve (not shown) positioned in line with exhaust system 16 may be used to apply a back pressure on the exhaust flow to thereby increase the exhaust temperature. Engine system 10 of the present disclosure may be configured to control exhaust temperature (i.e., elevate exhaust temperature) entirely by selectively increasing the mechanical load on engine 12, thereby eliminating the need for a heater, an inlet valve, and/or an outlet valve. Eliminating one or more of the heater, the inlet valve, and the outlet valve can reduce complexity and cost of engine system 10.

When increasing the mechanical load on engine 12 to artificially increase exhaust temperatures, the extra electrical power produced by primary generator 18 must be accommodated. That is, the extra electrical power must be drawn away from primary generator 18. In one embodiment, the extra electrical power can be dissipated through a series of resistive grids 36 that transfer the electrical power to the atmosphere in the form of heat. In another embodiment, which includes a heater (not shown), the extra electrical power can be directed to the heater and used to further increase exhaust temperatures. In yet another embodiment, some of the extra electrical power can be directed to resistive grids 36 and the remaining extra electrical power can be directed to the heater.

Artificially increasing the temperature of the exhaust flowing through aftertreatment component(s) 32 may be executed as part of a regeneration cycle. The regeneration cycle may be selectively initiated by a controller 38 based on one or more inputs 40. Inputs 40 may be received by controller 38 from numerous sensors and components of engine system 10. For example, controller 38 may be in communication with a throttle 42 and a reverser 44 for engine 12. Throttle 42 may be configured to send an input signal to controller 38 indicative of the throttle position of throttle 42. Reverser 44 may be configured to send an input signal to controller 38 indicative of the reverser position (e.g., forward, reverse, or center).

Controller 38 may also be in communication with one or more temperature sensor(s) 46 configured to send one or more signal(s) to controller 38 indicative of an exhaust temperature at one or more of the aftertreatment component(s) 32. For example, temperature sensors 46 could be associated with the DOC/DPF and/or the SCR. In another embodiment, temperature sensors 46 could be positioned upstream of the DOC/DPF and/or the SCR. Controller 38 may also be in communication with a temperature sensor 48 configured to send an input signal to controller 38 indicative of the ambient temperature in proximity to exhaust system 16.

Controller 38 may also be in communication with engine 12 and configured to receive several signals indicative of different engine parameters. For example, controller 38 may receive an input signal indicative of a fuel consumption rate (“fuel rate”), an input signal indicative of a coolant temperature, and an input signal indicative of an engine speed for engine 12.

In the disclosed embodiment, controller 38 may also be configured to receive input signals from a variety of other sensors. For example, flow sensors may provide flow rates and pressure sensors may provide pressures for exhaust flow through aftertreatment component(s) 32. The pressure sensors may be used to detect differential pressure across an aftertreatment component 32. The differential pressure may be used to indicate a level of absorption of hydrocarbons and other constituents within the aftertreatment component.

Controller 38 may embody a single or multiple microprocessors, field programmable gate arrays (FPGAs), digital signal processors (DSPs), etc., that are capable of controlling operations of engine system 10 in response to various input. Numerous commercially available microprocessors can be configured to perform the functions of controller 38. It should be appreciated that controller 38 could readily embody a microprocessor separate from those that control non-exhaust related functions, and that controller 38 may communicate with a general power unit processor via datalinks or other methods. Various other known circuits may be associated with controller 38, including power supply circuitry, signal-conditioning circuitry, actuator driver circuitry (i.e., circuitry powering solenoids, motors, or piezo actuators), communication circuitry, and other appropriate circuitry.

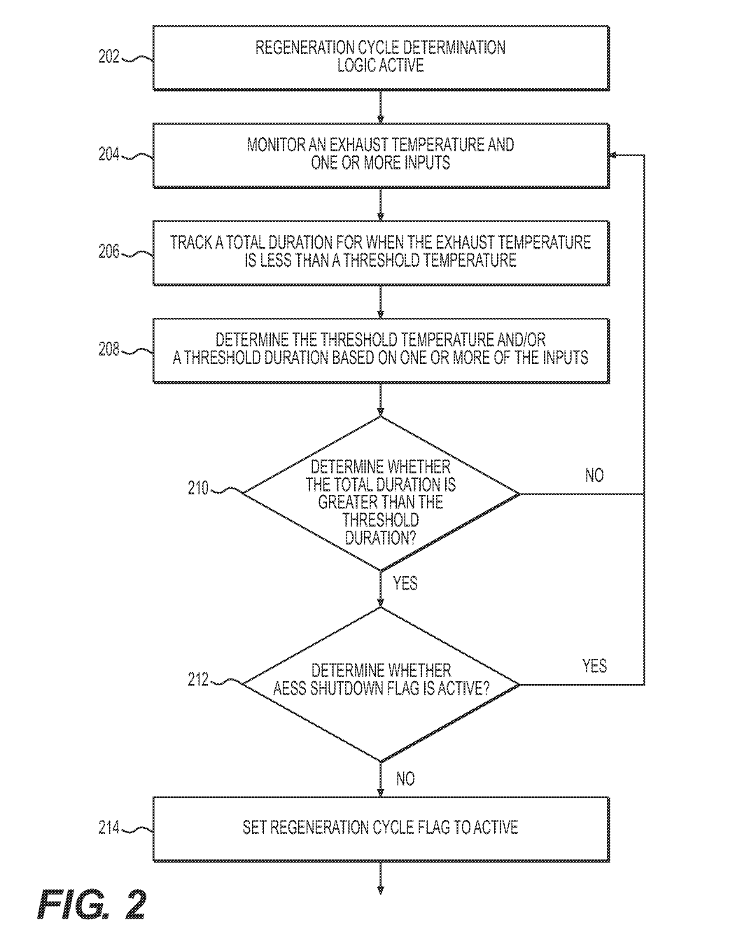

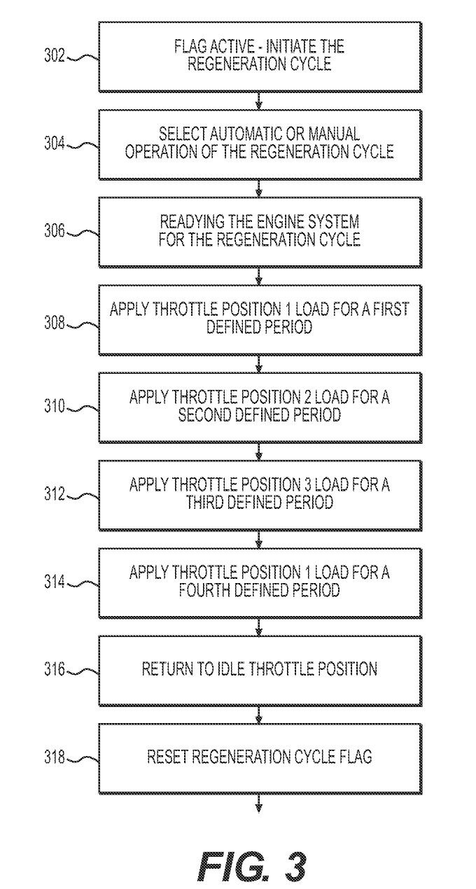

FIG. 2 illustrates an exemplary method of operating the engine system of FIG. 1. FIG. 3 illustrates an exemplary method of operating the engine system of FIG. 1 during a regeneration cycle. FIGS. 2 and 3 will be discussed in more detail below to better illustrate the disclosed concepts.

### INDUSTRIAL APPLICABILITY

The exhaust system of the present disclosure may be applicable to a variety of engines including, for example, diesel, gasoline, and gaseous fuel-powered engines. In fact, the disclosed exhaust system may be implemented into any new or existing engine having aftertreatment components that benefit from selective exhaust heating. For the purposes of the following disclosure, operation of engine system 10 will be described with regard to a locomotive.

During operation of engine system 10, compressor(s) 26 may draw in air, compress the air to a desired level, and direct the compressed air through cooler 22 into engine 12. Engine 12 may combust a mixture of the compressed air and fuel, generating the mechanical rotation that drives primary generator 18 and creates a flow of exhaust gases. The flow of exhaust gases may pass through duct 28, driving turbine(s) 30, and then through aftertreatment component(s) 32. The flow of exhaust gases may contain regulated constituents (e.g., particulates, hydrocarbons, etc.), which should be conditioned (e.g., trapped, oxidized, etc.) by aftertreatment component(s) 32.

Operation of engine system 10 as discussed herein may include stationary and motoring operation of the locomotive. Stationary operation may include idling, which in certain situations may last for extended periods. For example, in some situations the locomotive may be idling stationary for a day or more while being stored in a rail yard between trips.

While idling for extended periods, the temperature of exhaust passing through exhaust system 16 may drop due to the reduced loading on engine 12. Cold ambient temperatures may also cause and/or magnify the temperature drop of the exhaust. During low exhaust temperature operation, aftertreatment component(s) 32 may adsorb constituents (e.g., hydrocarbons) because the exhaust temperature is insufficient to oxidize the hydrocarbons allowing them to accumulate on the catalyst and other surfaces.

Controller 38 may be programmed to monitor operation of aftertreatment component(s) 32, engine 12, and other inputs and responsively determine a need to initiate a regeneration cycle. The regeneration cycle may be designed to increase the temperature of the exhaust flowing through aftertreatment component(s) 32 to a sufficiently high temperature based on the light-off curve for the constituents. Increasing the temperature can burn off or oxidize the constituents (particulates, hydrocarbons, etc.), thereby removing at least a portion of the constituents. Determining when there may be a need or when it may be preferable to initiate the regeneration cycle will first be discussed in more detail with regard to FIG. 2. Then the steps of the regeneration cycle will be discussed in more detail with regard to FIG. 3.

Controller 38 may be configured such that the regeneration cycle determination logic may be enabled or disabled by an operator or automatically through selective inputs. Therefore, the first step may be to set the regeneration cycle determination logic to active so controller 38 may execute the logic (step 202). Once the regeneration cycle determination logic is active, controller 38 may be configured to monitor the exhaust temperature and one or more signals from inputs 40 (step 204). Monitoring of the signals may continue throughout the execution of the regeneration determination logic.

While monitoring the exhaust temperature signal, controller 38 may be configured to track a total duration of time in which the exhaust temperature signal is less than a threshold temperature (step 206). The threshold temperature may correspond to the temperature at which constituents (e.g., hydrocarbons, particulates, etc.) may no longer get burned off or oxidized at a sufficient rate such that adsorption by aftertreatment component(s) 32 and other portions of exhaust system 16 may be occurring. Tracking the total duration during which adsorption may be taking place can provide an indication of the amount of accumulation of exhaust gas constituents.

This method of tracking may be suitable when engine system 10 is operating at steady state such that the rate of constituent production and adsorption is relatively consistent. However, this may not always be the case. In some situations, the level of constituents in the exhaust stream and the adsorption rate may vary during the period for which the exhaust temperature is below the threshold temperature. For example, engine system 10 and controller 38 may include an automatic start/stop mode (AESS) configured to increase energy efficiency when the locomotive is stationary for extend periods. The AESS mode may be configured to automatically shut down engine 12 when it has been, for example, idling for a defined duration (e.g., 15 minutes) and then restart engine 12 when, for example, coolant temperature or battery voltage drops below a threshold value thereby necessitating the restart of engine 12. Due to AESS mode, during extended periods of stationary operation the exhaust temperature may remain below the threshold temperature most or all of that time, but the engine may only be running and generating a flow of exhaust gas for a portion of the time. Not accounting for this shutdown time (e.g., stopping summing of the total duration) when tracking the total duration may lead to premature, excessive, and unnecessary triggering of the regeneration cycle.

In order to account for variability in the exhaust flow and the variability in the constituent level, the threshold temperature and/or a threshold duration may be varied. For example, controller 38 may be configured to determine the threshold temperature and/or the threshold duration based on one or more of the inputs 40 (step 208). Controller 38 may reference a data source to determine the threshold temperature and/or the threshold duration. In some embodiments, the threshold temperature may be fixed and controller 38 may reference the data source only to determine the threshold duration. The data source may be a lookup table, data map, database, spreadsheet, system of equations, etc. The data source may contain a range of threshold temperatures and threshold durations. Controller 38 may be configured to determine the threshold temperature and threshold duration based on one or more of the inputs 40. Inputs 40 may include, for example, the throttle position of throttle 42, the reverser position of reverser 44, the fuel consumption rate of engine 12, the speed of engine 12, the exhaust temperature, the coolant temperature of engine 12, the ambient temperature, etc. Controller 38 may be configured to factor in one or more of the inputs 40 to determine the threshold temperature and threshold duration from the data source. Several examples of how these inputs may be factored into the determination will be described below in greater detail.

The throttle position of throttle 42 may be utilized by controller 38 to determine the status of engine system 10. For example, controller 38 may use the throttle position to determine the portion of the total duration for which engine 12 was running (e.g., idling), and when engine system was shut down due to AESS mode. Utilizing this information, the threshold duration may be lengthened correspondingly to account for periods when engine 12 was not running and therefore not producing constituents or adding to the level of adsorbed constituents.

In conjunction with the throttle position, the position of reverser 44 may be utilized by controller 38 to determine the status of engine system 10. For example, engine system 10 may be configured such that AESS mode is enabled only when reverser 44 is in the center position. Therefore, based on the status of the reverser position, controller 38 may be alerted as to whether the engine 12 may have been shut down due to AESS mode.

The fuel consumption rate of engine 12 and/or the speed of engine 12 are inputs that may give an indication of the constituents in the exhaust generated by engine 12. For example, a higher engine speed or a higher fuel consumption rate may be expected to cause a greater amount of constituents to be exhausted from engine 12. Therefore, based on these inputs, controller 38 can be configured to adjust accordingly in determining or selecting the threshold temperature and the threshold duration from the data source.

The exhaust temperature, the coolant temperature of engine 12, and/or the ambient temperature may each independently provide an indication of the level of constituent accumulation in exhaust system 16. For example, as discussed herein, when the exhaust temperature at the aftertreatment components is low, aftertreatment component(s) 32 can adsorb constituents because the light-off temperature curve does not have sufficient temperature to completely burn off or oxidize the constituents. Regarding, the coolant temperature, it would be expected to rise and fall correspondingly to engine 12 operation, as would the exhaust temperature. Therefore, constituent accumulation levels can be expected to increase as coolant temperature decreases because exhaust temperature correspondingly decreases. With regard to ambient temperature, the constituent accumulation rate would be expected to increase as ambient temperature decreases due to the increased rate of heat transfer based on the increased temperature gradient. The constituent accumulation rate would also be expected to increase along the length of exhaust system 16 due to the increased duration of exposure to the ambient air temperature.

Controller 38 may be configured to account for variability in the exhaust flow by integrating one or more of the inputs 40 into the determination of the threshold temperature and/or the threshold duration. For example, controller 38 may reference a data map of threshold temperatures and threshold durations and may take into account the one or more inputs 40 when selecting the threshold temperature and the threshold duration. Controller 38 may take into account, for example, the value of an input 40, the duration of an input 40, or a combination thereof.

Following step 208, controller 38 may determine whether the total duration is greater than the threshold duration (step 210). If the total duration is not greater than the threshold duration then controller 38 can return to the logic of steps 204 to step 208 (step 210: No). Controller 38 can be configured to continue cycling through steps 204 to step 210. Thus, the threshold temperature and the threshold duration may vary (e.g., continuously or periodically) during operation as a result of controller 38 cycling through step 204 to step 210. This continuous cycling and updating of the determination (step 208) can allow controller 38 to react to changing conditions of the exhaust flow from engine 12. By taking into account one or more of the inputs 40 and continuing to update the threshold values (i.e., the threshold temperature and/or the threshold duration), controller 38 can determine the threshold values based on the current and past conditions of engine system 10. As a result, controller 38 can be configured such that the total duration exceeds the threshold duration at the point when adsorption has generally reached a threshold and it is most advantageous to initiate the regeneration cycle.

Once the total duration is greater than the threshold duration (step 210: Yes), then controller 38 can determine whether the AESS mode shutdown flag is active (step 212). If engine 12 is shutdown, the AESS mode shutdown flag will be active. If engine 12 is running, the AESS mode shutdown flag will not be active. If engine 12 is shut down at the time when controller 38 reaches step 212 (step 212: Yes), the regeneration cycle can be delayed until engine 12 is running by having controller 38 return to step 204 and repeat steps 204 to 212. If the AESS shutdown flag is not active (step 212: No), controller 38 may proceed and set the regeneration cycle flag to active (step 214).

Following activation of the regeneration cycle flag (step 214) a regeneration cycle may be initiated (step 302). The regeneration cycle may be carried out automatically or manually. An operator may select automatic or manual mode for the regeneration cycle (step 304). Engine system 10 may be configured such that selection of automatic or manual is not required for each regeneration cycle, but rather the default will be the last selection made by the operator. Therefore, a regeneration cycle may be initiated and performed primarily without operator intervention. If automatic regeneration is selected, engine system 10 may perform the following steps automatically. If manual regeneration is selected the following steps may be manually performed by the operator. The operator may be provided instructions corresponding to each step via a display panel.

The next step is readying engine system 10 for the regeneration cycle (step 306). Readying engine system 10 for the regeneration cycle may include one or more operations, for example, applying the brakes, readying generator 18 for loading of engine 12, and/or an initial safety check of engine system 10. It is contemplated that various other operations may be performed as part of readying engine system 10 for the regeneration cycle.

Once the engine system 10 is ready for the regeneration cycle, a throttle position 1 (TN1) load can be applied to engine 12 by generator 18 (step 308). The TN1 load can be applied to engine 12 for a first defined period, for example, about 60 seconds. Applying the load to engine 12 causes engine 12 to increase output and thereby cause an increased rate of combustion and an increase in the temperature of exhaust exiting engine 12. While applying the TN1 load, the temperature of exhaust exiting engine 12 and passing through exhaust system 16 may increase to, for example, about 120 degrees Celsius. Next, a throttle position 2 (TN2) load can be applied to engine 12 by generator 18 (step 310). The TN2 load can be applied to engine 12 for a second defined period, for example, about 120 seconds. While applying the TN2 load, the temperature of exhaust passing through exhaust system 16 may increase to, for example, about 200 degrees Celsius.

Next, a throttle position 3 (TN3) load can be applied to engine 12 (step 312). The TN3 load can be applied to engine 12 for a third defined period, for example, about 180 seconds. While applying the TN3 load, the temperature of exhaust passing through exhaust system 16 may increase to, for example, about 425 degrees Celsius.

Incrementally stepping up of the throttle position from TN1 to TN2 to TN3 can result in the temperature of the exhaust gradually increasing in a controlled manor. If the exhaust temperature is increased too rapidly when there are accumulated constituents in aftertreatment component(s) 32, the constituents may ignite uncontrollably. Damage to aftertreatment component(s) 32 as well as an undesired discharge of constituents (e.g., white smoke plume) may be caused by uncontrolled ignition of the constituents. In consideration of these concerns, the incremental increase of the exhaust temperature during the regeneration cycle may be configured to reduce the likelihood or prevent ignition of the accumulated constituents in aftertreatment component(s) 32. In the exemplary embodiment, this incremental increase may involve maintaining the exhaust temperature at different increments for a period of time. The periods of time may be different or they may be the same and there may be more or less than three increments.

Following the application of the TN3 load for the third defined period, the throttle may then be returned to TN1 and a TN1 load can be applied to engine 12 (step 314). The TN1 load can be applied for a fourth defined period, for example, about 60 seconds. Following the conclusion of the fourth defined period, the throttle 42 may be returned to the idle throttle position (step 316) and then controller 38 can reset the regeneration cycle flag (step 318). The engine system 10 may also be configured to instruct to the operator (e.g., via the display panel) to release the brakes that were applied while readying engine system 10 for the regeneration as part of step 304. Following the reset of the regeneration cycle flag (step 318), controller 38 may return to the regeneration cycle determination logic at step 202.

It will be apparent to those skilled in the art that various modifications and variations can be made to the exhaust system without departing from the scope of the disclosure. Other embodiments will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. An exhaust system for an engine, comprising:
an exhaust passage configured to direct exhaust from the engine to the atmosphere;
an aftertreatment component disposed within the exhaust passage;
a throttle configured to generate a throttle position signal indicative of a throttle position of the engine;
a temperature sensor configured to generate a temperature signal indicative of the exhaust temperature; and
a controller in communication with the engine, the throttle, the sensor, and the aftertreatment component, configured to:
monitor the temperature signal and track a total duration for which the temperature signal is less than a threshold temperature; and
initiate a load increase on the engine to raise a temperature of exhaust exiting the engine when the total duration is greater than a threshold duration;
wherein the threshold temperature and the threshold duration vary during operation of the engine, and are determined by the controller based on one or more inputs including at least the throttle position.

2. The exhaust system of claim 1, wherein the throttle position in conjunction with a reverser position is used to determine the duration of time the engine is running versus shutdown.

3. The exhaust system of claim 1, wherein the inputs include at least one of an engine speed, a fuel consumption rate of the engine, a reverser position, an ambient temperature, and a coolant temperature.

4. The exhaust system of claim 1, wherein initiating the load increase includes incrementally stepping up the throttle position of the engine, which causes the exhaust temperature to incrementally increase.

5. The exhaust system of claim 1, wherein initiating the load increase is performed automatically by the controller and initiating the load increase includes operating the engine at a first throttle position for a first period, operating the engine at a second throttle position for a second period, operating the engine at a third throttle position for a third period, and returning to the first throttle position for a fourth period before returning to idle.

6. The exhaust system of claim 1, wherein determining the threshold temperature and the threshold duration includes referencing a data map of threshold temperatures values and threshold durations values.

7. The exhaust system of claim 1, wherein the aftertreatment component includes at least one of a particulate filter, a diesel oxidation catalyst, and a selective catalytic reduction device.

8. The exhaust system of claim 1, wherein the load increase on the engine is configured to gradually increase the temperature of the exhaust to a sufficient temperature such that at least a portion of hydrocarbons adsorbed by the aftertreatment component are oxidized.

9. The exhaust system of claim 1, wherein the engine drives a generator to produce electrical power directed to a traction motor, and the electrical power is directed to a resistive grid when the load increase is initiated.

10. The exhaust system of claim 1, wherein the aftertreatment component is a diesel oxidation catalyst and the load increase raises the temperature of the exhaust to a temperature sufficient to oxidize hydrocarbons adsorbed within the diesel oxidation catalyst.

11. A method of controlling an exhaust system for an engine, comprising:
receiving a temperature signal indicative of an exhaust temperature;
receiving a throttle position signal indicative of a throttle position of the engine;
monitoring the temperature signal and tracking a total duration for which the temperature signal is less than a threshold temperature; and
initiating a load increase on the engine to raise a temperature of exhaust exiting the engine when the total duration is greater than a threshold duration;
wherein the threshold temperature and the threshold duration vary during operation of the engine, and are determined based on one or more inputs including at least the throttle position.

12. The method of claim 11, wherein the throttle position in conjunction with a reverser position is used to determine the duration of time the engine is running versus shutdown.

13. The method of claim 11, wherein the inputs include at least one of an engine speed, a fuel consumption rate of the engine, a reverser position, an ambient temperature, and a coolant temperature.

14. The method of claim 11, wherein initiating the load increase includes incrementally stepping up the throttle position of the engine, which causes the exhaust temperature to incrementally increase.

15. The method of claim 11, wherein initiating the load increase is performed automatically by the controller and initiating the load increase includes:
operating the engine at a first throttle position for a first period,
operating the engine at a second throttle position for a second period,
operating the engine at a third throttle position for a third period, and
returning to the first throttle position for a fourth period before returning to idle.

16. The method of claim 11, wherein determining the threshold temperature and the threshold duration includes referencing a data map of threshold temperatures values and threshold durations values.

17. The method of claim 11, wherein initiating a load increase on the engine gradually increases the temperature of the exhaust to a sufficient temperature such that at least a portion of hydrocarbons adsorbed by an aftertreatment component are oxidized.

18. The method of claim 11, wherein the aftertreatment component is a diesel oxidation catalyst and the load increase raises the temperature of the exhaust to a temperature sufficient to oxidize hydrocarbons adsorbed within the diesel oxidation catalyst.

19. The method of claim 11, wherein initiating a load increase on the engine increases the temperature of the exhaust at a sufficiently gradual rate such that ignition of hydrocarbons adsorbed by the aftertreatment components is prevented.

20. An engine system, comprising:
an engine;
an exhaust manifold extending from the engine;
a turbocharger connected to the exhaust manifold;
at least one exhaust passage connected to an outlet of the turbocharger configured to direct exhaust to the atmosphere;
an aftertreatment component disposed within the exhaust passage;
a throttle configured to generate a throttle position signal indicative of a throttle position of the engine;
a temperature sensor configured to generate a temperature signal indicative of the exhaust temperature; and
a controller in communication with the engine, the throttle, the sensor, and the aftertreatment component, configured to:
monitor the temperature signal and track a total duration for which the temperature signal is less than a threshold temperature; and
initiate a load increase on the engine to raise a temperature of exhaust exiting the engine when the total duration is greater than a threshold duration;
wherein the threshold temperature and the threshold duration vary during operation of the engine, and are determined based on one or more variables including at least the throttle position.
